(19) United States
(12) Patent Application Publication
(10) Pub. No.: US 2008/0295343 A1
(43) Pub. Date: Dec. 4, 2008

(54) KITCHEN UTENSIL WITH MULTIPLE INTEGRALLY FORMED RESTING SURFACES

(76) Inventors: Christopher Mattingly, Carol Stream, IL (US); Patrick Kerulis, West Chicago, IL (US); Arlin Tao, Lisle, IL (US)

Correspondence Address: MCDERMOTT, WILL & EMERY LLP, 227 WEST MONROE STREET, SUITE 4400, CHICAGO, IL, 60606-5096, US

(21) Appl. No.: 11/756,118

(22) Filed: May 31, 2007

(51) Int. Cl. A47J 43/28

(52) U.S. Cl. 30/324

(57) ABSTRACT

A kitchen utensil comprised of an elongated member and an implement is provided. The elongated member has a proximal end and a distal end and a longitudinal axis. The implement has a proximal edge and a distal edge. The proximal edge of the implement is connected to the distal end of the elongated member. The kitchen utensil also includes a plurality of grooves integrally formed into the elongated member. The grooves are disposed along an axis transverse to the longitudinal axis and proximate the distal end of the elongated member. Each of the grooves has a groove width and groove depth. The groove width of at least one of the grooves is greater than the groove width of at least one of the other of the grooves.

### TECHNICAL FIELD

The invention relates to a kitchen utensil, and more particularly, to a kitchen utensil having integrally formed resting surfaces.

### BACKGROUND OF THE INVENTION

When cooking, mixing or eating food, it is often necessary to rest a cooking utensils while performing other cooking, mixing or eating steps. It is also desirable that the cooking utensil be rested near the site of the cookware or dishware so that the utensil is readily accessible. There exists utensils that include a single notch in their handles to allow a user to rest a utensil on the rim of cookware. However, such single notch utensils have certain inherent drawbacks and suffer several disadvantages inherent with their configuration. Most particularly, the single notch configuration accommodates only a single cookware rim size. Accordingly, there is a need for providing a utensil that accommodates cooperative engagement with cookware rims of varying sizes. However, merely including multiple notches in a utensil could result in diminishing structural integrity to the implement. Accordingly, there also exist a need to provide a utensil that accommodates cooperative engagement with cookware rims of varying sizes, while maintaining the structural integrity of the utensil.

The present invention is provided to solve the problems discussed above and other problems, and to provide advantages and aspects not provided by prior kitchen utensils by, among other things, optimizing the number, placement and dimensions of the notches. A full discussion of the features and advantages of the present invention is deferred to the following detailed description, which proceeds with reference to the accompanying drawings.

### SUMMARY OF THE INVENTION

According to the present invention, a kitchen utensil comprised of an elongated member and an implement is provided. The elongated member has a proximal end and a distal end. The elongated member also has longitudinal axis. The implement has a proximal edge and a distal edge. The proximal edge of the implement is connected to the distal end of the elongated member. The kitchen utensil also includes a plurality of grooves integrally formed into the bottom surface portion of the elongated member. The grooves are disposed along an axis transverse to the longitudinal axis and proximate the distal end of the elongated member. Each of the grooves has a groove width and groove depth. The groove width of at least one of the grooves is greater than the groove width of at least one of the other of the grooves.

According to one aspect of the present invention, the implement is integrally coupled to the distal end of the elongated member.

According to another aspect of the present invention, the kitchen utensil includes a first groove and a second groove integrally formed into the bottom surface of the elongated member along an axis transverse to the longitudinal axis. The second groove is disposed closer to the implement than the second groove and in parallel relationship to the first groove. The first groove has a first groove width W₁. The second groove has a second groove width W₂, and either the first groove width W₁ or the second groove width W₂ is greater than the other of the first groove width W₁ and the second groove width W₂.

According to another aspect of the present invention, at least a portion of at least one of the first and second grooves includes a silicone coating.

According to still another aspect of the present invention, the first groove has first groove depth D₁ and the second groove has a second groove depth D₂. According to one embodiment, either the first groove depth D₁ or the second groove depth D₂ is greater than the other of the first groove depth D₁ and the second groove depth D₂.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a kitchen utensil according to the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

According to the present invention, a kitchen utensil 10 is provided. More particularly, a kitchen utensil is provided that includes an integrally formed mechanism for resting the utensil 10 in close proximity to a cookware item such as for instance a pot or a pan, while cooking. More particularly, the present kitchen utensil 10 is provided to facilitate cooperative engagement between the utensil 10 and the rim of a cookware item.

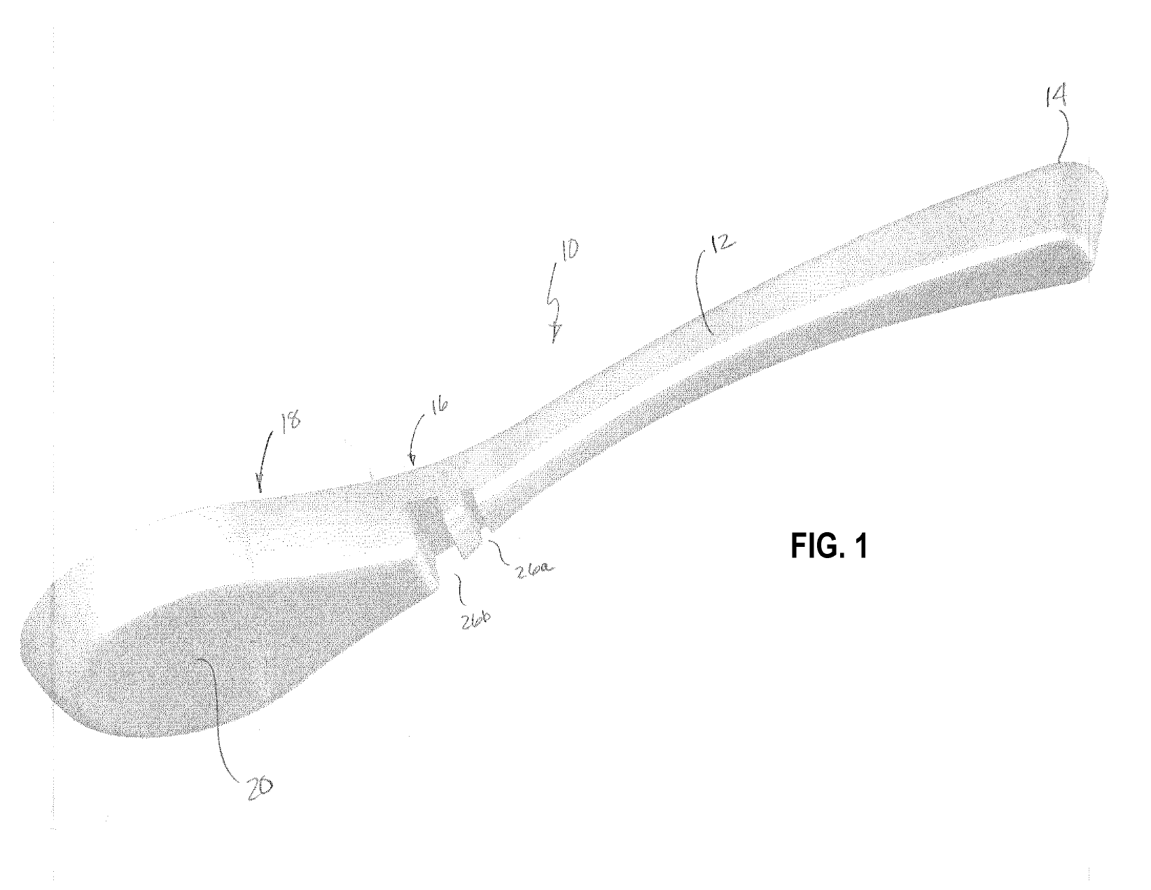

Referring now to FIG. 1, the kitchen utensil 10 is comprised of an elongated member 12 and an implement 18. The elongated member 12, or handle, has a proximal end 14, and an opposed distal end 16. The elongated member 12 also includes a longitudinal axis. It will be understood that, although the elongated member 12 generally has a longitudinal axis, the profile of the elongated member 12 can be curved (as shown in FIG. 1), generally linear, or assume any other profile or configuration suitable for a kitchen utensil 10 handle. The elongated member 12 also has a top surface portion and a bottom surface portion. It should be understood that, although the these surfaces are, at times, described herein as being a top surface and a bottom surfaces, the top and bottom surfaces of the present invention can be integrally formed and present no clearly describable transition. As such, it is appropriate that general reference is made herein to a top portion and a bottom portion of the elongated member 12.

According to the present invention, the elongated member 12 can be a solid or hollow member formed of any material suitable for kitchen utensil handles. For example, it is contemplated that the elongated member 12 of the present invention is formed from, plastic, silicone, wood, glass, stainless steel, or any other suitable material. It is also contemplated that the elongated member 12 can be composed of a combination of materials and include inlays or gripping materials necessary to assist a user in handling the utensil 10. It will also be understood that the elongated member 12 be composed of a single segment or multiple segments coupled one to the other by suitable fasteners or connectors.

The utensil 10 of the present invention further includes an implement 18. As shown in FIG. 1, the implement 18 has a proximal edge and a generally opposed distal edge. According to the present invention, the implement 18 is adapted to be used in connection with kitchen applications such as eating, cooking, mixing, stirring, serving or the like. For example, the implement 18 may be configured as a generally concave dish 20 to define a spoon cavity. In another example, the implement 18 is configured as a spatula. In yet another example, the implement 18 includes a plurality of tines extending generally longitudinally from the distal end 16 to define a fork or similar implement. Although the examples described above are representative of the types of implements for which the present invention can be adapted, the present invention should not be limited to such implement 18 configurations. Instead, it is contemplated that the implement 18 can be configured in the form of any kitchen utensil having a handle extending from one end.

As shown in FIG. 1, the proximal edge of the implement 18 is connected to the distal end 16 of the elongated member 12. According to the present invention, the implement 18 can be a distinct member connected by a suitable fastener or connecter to the elongated member 12. For example, the implement 18 and elongated member 12 can include a cooperative threading assembly whereby the implement 18 can be screwed to the elongated member 12. In another example, the implement 18 and elongated member 12 can have cooperatively engaging male and female components that engage on another by friction fit or snap-lock mechanisms. It will be understood by one of ordinary skill that these are but examples of many suitable mechanisms for operably connecting the implement 18 to the handle 12 (i.e., the elongated member 12), and that any such suitable mechanisms may be employed without departing for the present invention. Alternatively, the proximal edge of the implement 18 can be integrally formed with the distal end 16 of the elongated member 12 such that the utensil 10 is a unitary piece.

As shown in FIG. 1, the kitchen utensil 10 also includes a plurality of grooves 26 integrally formed into the bottom surface portion of the elongated member 12. The grooves 26 are disposed along an axis transverse to the longitudinal axis and near the distal end 16 of the elongated member 12. Each of the grooves 26 has a groove width and groove depth. According to the present invention, and as described with reference to one embodiment below, the groove width of at least one of the grooves 26 is greater than the groove width of at least another of the grooves 26. According to one embodiment of the present invention, at least a portion of the grooves 26 can include a silicone coating. The silicone coating provides protection to the grooves 26 and assists in preventing distortion of the groove width that may be caused by intense heat as the utensil 10 is cooperatively engaged with a cookware item.

The relative number, placement and dimensions of the grooves 26 in the elongated member 12 are informative of the resultant integrity of the utensil 10 and play a critical role in the invention that could not be discerned from the prior art; particularly, in those prior art utensils having only a single notch. Accordingly, in one embodiment of the invention shown, the elongated member 12 has a fist groove and a second groove 26b. As described above, the first and second groove 26b are integrally formed into the bottom surface portion of the elongated member 12 and are positioned along an axis transverse to the longitudinal axis. More particularly, the second groove 26b is disposed closer to the implement 18 than the first groove 26a and in parallel relationship to the first groove 26a. In one embodiment shown in FIG. 7, the first groove 26a has a first groove 26a width W₁ and a first groove 26a depth D₁. Similarly, the second groove 26b has a second groove 26b width W₂ and a second groove 26b depth D₂.

According to the embodiment shown, the first groove 26a width W₁ is greater than the second groove 26b width W₂. In one preferred embodiment the first groove 26a width W₁ is in the range of approximately 0.20 to 0.50 inches, and more preferably in the range of 0.25 to 0.40 inches. Most preferably, the first groove 26a width W₁ is 0.25 inches.

As discussed above, the first and second grooves 26a, 26b also have a first groove 26a depth D₁ and a second groove 26b depth D₂, respectively. In one embodiment of the invention, either the first groove 26a depth D₁ or the second groove 26b depth D₂ is greater than the other of the first groove 26a depth D₁ and the second groove 26b depth D₂. However, it is contemplated that the first groove 26a depth D₁ and the second groove 26b depth D₂ be of any depth suitable to ensure cooperative engagement of the handle 12 of the kitchen utensil 10 with the sidewall of a desired cookware item, including that the first groove 26a and the second groove 26b be of equal depth (i.e., D₁=D₂).

While the specific embodiments have been illustrated and described, numerous modifications come to mind without significantly departing from the spirit of the invention, and the scope of protection is only limited by the scope of the accompanying Claims.

What is claimed is:

1. A kitchen utensil comprising:
an elongated member having a proximal end and a distal end, the elongated member further having a longitudinal axis;
an implement having a proximal edge and a distal edge, the proximal edge of the implement being connected to the distal end of the elongated member; and,
a plurality of grooves integrally formed into the elongated member along an axis transverse to the longitudinal axis and proximate the distal end of the elongated member, each of the plurality of grooves having a groove width and groove depth, the groove width of at least one of the plurality of grooves being greater than the groove width of at least one of the other of the plurality of grooves.

2. The kitchen utensil of claim 1, wherein the implement is a concave dish.

3. The kitchen utensil of claim 1, wherein the implement is a spatula.

4. The kitchen utensil of claim 1, wherein the implement further comprises a plurality of tines extending generally longitudinally the distal edge.

5. The kitchen utensil of claim 1, wherein the groove depth of at least one of the plurality of grooves is greater than the groove depth of at least one of the other of the plurality of grooves.

6. The kitchen utensil of claim 1, wherein at least a portion of at least one of the plurality of grooves includes a silicone coating.

7. A kitchen utensil comprising:
a elongated member having a proximal end, a distal end, a top surface portion and a bottom surface portion, the elongated member further having a longitudinal axis;
an implement having a proximal edge and a distal edge, the proximal edge of the implement being integrally coupled to the distal end of the elongated member; and,
a first groove integrally formed into the bottom surface portion of the elongated member along an axis transverse to the longitudinal axis, the first groove having a first groove width W₁;
a second groove integrally formed into the bottom surface portion of the elongated member along an axis transverse to the longitudinal axis, the second groove being disposed closer to the implement than the first groove and in parallel relationship to the first groove, the second groove having a second groove width W₂, wherein one of either the first groove width W₁ and the second groove width W₂ is greater than the other of the first groove width W₁ and the second groove width W₂.

8. The kitchen utensil of claim 7, wherein the implement is a concave dish.

9. The kitchen utensil of claim 7, wherein the implement is a spatula.

10. The kitchen utensil of claim 7, wherein the implement further comprises a plurality of tines extending generally longitudinally from the distal edge.

11. The kitchen utensil of claim 7, wherein at least a portion of at least one of the first groove and the second groove includes a silicone coating.

12. A kitchen utensil comprising:
a elongated having a proximal end, a distal end, a top surface portion and a bottom surface portion, the elongated member further having a longitudinal axis;
an implement having a proximal edge and a distal edge, the proximal edge of the implement being connected to the distal end of the elongated member; and,
a first groove integrally formed into the bottom surface portion of the elongated member along an axis transverse to the longitudinal axis, the first groove having a first groove width W₁ and first groove depth D₁;
a second groove integrally formed into the bottom surface portion of the elongated member along an axis transverse to the longitudinal axis, the second groove being disposed closer to the implement than the first groove and in parallel relationship to the first groove, the second groove having a second groove width W₂ and second groove depth D₂, wherein the first groove width W₁ is greater than the second groove width W₂.

13. The kitchen utensil of claim 12, wherein the first groove width W₁ is in the range of approximately 0.25 to 0.50 inches.

14. The kitchen utensil of claim 12, wherein one of either the first groove depth D₁ and the second groove depth D₂ is greater than the other of the first groove depth D₁ and the second groove depth D₂.

15. The kitchen utensil of claim 12, wherein the implement is a concave dish.

16. The kitchen utensil of claim 12, wherein the implement is a spatula.

17. The kitchen utensil of claim 12, wherein the implement further comprises a plurality of tines extending generally longitudinally from the distal edge.

18. The kitchen utensil of claim 12, wherein at least a portion of at least one of the first groove and the second groove includes a silicone coating.

19. The kitchen utensil of claim 12, wherein kitchen utensil is formed from a thermal set polymer.
